(19) United States
(12) Patent Application Publication
(10) Pub. No.: US 2011/0055258 A1
(43) Pub. Date: Mar. 3, 2011

(54) METHOD AND APPARATUS FOR THE PAGE-BY-PAGE PROVISION OF AN ELECTRONIC DOCUMENT AS A COMPUTER GRAPHIC

(76) Inventor: Alex Racic, Pullach (DE)

(21) Appl. No.: 12/918,258

(22) PCT Filed: Feb. 5, 2009
(86) PCT No.: PCT/EP2009/051343

§ 371 Date: Nov. 15, 2010

(30) Foreign Application Priority Data
Feb. 19, 2008 (DE) 102008010264.4

(51) Int. Cl. G06F 17/30; G06F 17/22

(52) U.S. Cl. 707/769; 715/235; 707/E17.014

(57) ABSTRACT

Method for providing at least one page of a virtual electronic document as a computer graphic, having the following steps: selection of at least one content data element for a virtual electronic document; determination of formatting data; calculation, for the content data element, of a page identification value and of an element position value on the page; storage of an association between content data element, page identification value and element position value in a database; evaluation of a request for a page of the virtual electronic document; determination, by accessing the database, of at least one contact data element and element position value of the content data element which correspond to the page identification value of the requested page; calculation of a computer graphic on the basis of the formatting data, the content data element determined for the requested page and the associated element position value; provision of the computer graphic as a page of the virtual electronic document for the purpose of display, and also an apparatus, an arrangement and a computer program product therefor.

### TECHNICAL FIELD

The invention relates to a method for the provision of at least one page of an electronic document as a computer graphic for retrieval via a network, and to an apparatus, an arrangement, and a computer program product therefor.

### BACKGROUND TO THE INVENTION

In order to be able to provide electronic documents, such as e-books, reliably, quickly and flexibly for a large number of users to read, it is known practice to provide said electronic documents for retrieval via a server, for example a web server or FTP server.

This can involve the transmission of a file which contains the electronic document in full, for example in order to be able to be read by the user independently of a current network connection. This typically requires large files, which produce a corresponding download, even before the first page can be displayed, and a corresponding amount of storage space is taken up in the viewer. In addition, it is known practice to transmit individual pages of the electronic book which have been retrieved from the server previously by the user or his viewer.

In both variants, the contents of the book or the individual pages of the book can be transmitted in a file of a page description language, with the content elements of the book or of the page (such as text, diagrams, graphics) forming objects which are respectively encoded in their relevant format and are arranged relative to the page of the book by the page description language. In this context, the viewer interprets the instructions contained in the page description file and accordingly joins together the text elements, for example available in character-encoded form, and graphic elements, available as a raster graphic file, to produce the electronic document. Examples of such page description languages are PostScript (PS) or the Portable Document Format (PDF) or the Device Independent file format (DVI).

On the other hand, the entire document or individual pages can also be transmitted in the form of a computer graphic file in which all content elements of the electronic page of the book are encoded together in a raster or vector graphic. Such graphical transmission has the advantage that the contents are protected against undesirable, simple copying and further use, since the text characters are available not as such but rather only in their graphic representation. On the other hand, however, this significantly complicates working with the text, for example searching for text or adding marginal notes, and also marking and further processing of text passages.

The German translation DE 694 34 434 T2 of the European patent specification EP 0 731 948 B1 discloses a system for the user-friendly display and handling of electronic document pages which are available as a computer graphic, wherein the computer graphics come from scanned-in pages of printed patent documents, and in which the text presented in the computer graphics is also available in a parallel data management system in character-encoded form. In this case, the pagination of scanned-in printed pages of patent specifications is recreated in the character-encoded text form, and a form of presentation is possible in which the text graphic and the character-encoded text are presented in windows situated beside one another. This double approach firstly provides the faithful graphical representation and secondly allows the character-encoded text to be processed further, particularly searching and navigating within a document.

However, this requires double presentation of the contents, since user access to the text content elements is possible only in the presentation window of the character-encoded text. This double presentation can reduce reading comfort, however, and uses up a larger presentation area than single presentation. In addition, this system requires both the graphically encoded pages and the character-encoded text to be transmitted from the server to the client, which results in a higher communication load. Furthermore, the text is not protected against undesirable further processing in this case, since it is available to the user in character-encoded form.

It is therefore an object of the present invention to specify a method which allows pages of an electronic document to be provided for retrieval via a network and at the same time avoids the drawbacks of the prior art, particularly complicates undesirable electronic further processing of the contents and improves storage and data transmission efficiency, and also an apparatus, an arrangement and a computer program product therefor.

### OVERVIEW OF THE INVENTION

The invention achieves this object by means of the respective subject matter of claims 1, 16, 17, 18, 19 and 20.

The invention according to claim 1 teaches a method for the provision of at least one page of a virtual electronic document as a computer graphic for retrieval via a network, having the following steps:
at least one content data element is selected for a virtual electronic document;
the formatting data are determined for the virtual electronic document;
a page identification value for a page of the virtual electronic document and an element position value on the page identified by the page identification value are calculated for the at least one content data element on the basis of the formatting data;
an association for the content data element, the page identification value of the content data element and the element position value of the content data element is stored in a database;
a request for a page of the virtual electronic document is evaluated to determine a page identification value for the requested page;
the database is accessed to determine at least one content data element and an element position value for the content data element which correspond to the page identification value of the requested page;
a computer graphic is calculated on the basis of the formatting data, the content data element determined for the requested page and the associated element position value;
the computer graphic is made available as a page of the virtual electronic document for presentation.

As a result of the invention not keeping content elements in an actual electronic document, but rather the content elements to be provided being only virtual components of an electronic document, but actually being managed by a database, a form of data management and data organization is chosen which can be stored more efficiently in comparison with a conventional electronic document and is flexible to handle. From the database it is possible for the content data elements, such as character-encoded words of the document text, references to graphic objects, and the like, to be individually addressed and retrieved directly using the page calculated for each of the content data elements in the virtual document and the position (e.g. the coordinates) on the page, without the need to search through an electronic document for this purpose. The use of a database is particularly advantageous when a database management system (DBMS) is used and a large number of extensive documents are provided on a server.

As a result of the content data elements of the virtual electronic document respectively having the page thereof and position on the page calculated for them and both being associated with the respective content data element, the individual and direct accessibility in the database is ensured. It therefore becomes possible to retrieve all content data elements of the page from the database, and also to arrange them relative to one another, by specifying a page of the virtual document. It also becomes possible to explicitly address a particular content data element, for example a character-encoded word, by specifying its page and position on the page. This allows character-encoded words to be processed on the basis of their graphical position.

As a result of a page being prepared for presentation and then made available for retrieval on the basis of a request, for example by a viewer, the loading time for the page chosen by the viewer is shortened, and only the page to be presented needs to be kept on the viewer. This is particularly advantageous for mobile viewers, for example mobile telephones or personal digital assistants (PDAs). Particularly in connection with the graphical provision of the page, the advantage arises that it is not necessary for every graphically presented page to be held in memory in order to provide it for retrieval, since it is produced dynamically upon retrieval using the database information.

By creating a computer graphic of the requested page, for example by converting the content data elements of the requested page into their graphical representation and arranging and combining them in a raster or vector computer graphic using their position information, and then making the computer graphic available for retrieval via the network, the user is merely provided with graphically encoded data, which complicates undesirable further processing of textual contents of the electronic document, for example.

Overall, efficient storage of the contents forming an electronic document is therefore achieved when they are kept for provision, and also when the electronic document is retrieved, and at the same time individual addressability of the content elements on which the presentation is based becomes possible without the need for double data management or double presentation. In addition, undesirable further processing by the user is made more difficult.

Further embodiments of the invention according to claim 1 can be realized in line with the subclaims which refer back to this claim.

By way of example, the invention can be developed by virtue of the request for a page of the virtual electronic document being evaluated when the request is received by a web server and/or the computer graphic being made available through the transmission of a graphic file by a web server.

Developments can be realized by virtue of an access command for a content data element of the made-available page of the virtual electronic document being evaluated on the basis of the element position value thereof. This allows individual content data elements, e.g. individual words of the text, to be denoted by a position statement (element position value) for the graphical representation thereof in the page, for example as a result of a mouse click, the character-encoded form to be retrieved from the database using the element position value, and said form to be provided for further processing. Accordingly, developments may be characterized in that the content data element associated with the page identification value of the made-available page and with the element position value is ascertained by accessing the database.

The method may be developed in that a search command associated with a search term is evaluated and content data elements of the virtual electronic document are ascertained which correspond to the search term. It is therefore possible to provide a search function even though merely a graphical representation of the page is provided for retrieval.

Developments of the invention may be characterized in that the formatting data comprise a page width value and/or a page height value and/or a text area width value and/or a text area height value. This allows stipulation of the page format and of the printed area of the virtual electronic document, or of the pages generated for presentation.

In embodiments of the invention, the element position value can be calculated by calculating the dimensions of the content data element, and a sequence of content data elements can be selected.

In embodiments of the method, a row can be calculated to horizontally join together the successive content data elements on the basis of the addition of the width of the respective content data element until the text area width value has been reached and/or exceeded. This row is a calculation row, the dimensions of which are used to calculate the position of the words and which is used as a computational organization means for content data elements. By contrast, the (text) rows of the document which are presented are obtained only when the document page computer graphic is generated.

Correspondingly, in embodiments, a page can be calculated to vertically join together the successive rows on the basis of the addition of the height of the rows until the text area height value has been reached, wherein the height of a row is determined by the highest content data element of the row. Here, again, the page is a calculation page, the dimensions of which are used to calculate the position of the words and which is used as a computational organization means for calculation rows and hence content data elements.

Embodiments of the invention may be characterized in that the content data element is allocated that page identification value which corresponds to the calculated page to which the content data element has been appended.

In developments of the method, the content data element can be allocated that element position value which corresponds to the position of the content data element on the calculated page to which the content data element has been appended.

In developments of the invention, the content data element may have a text element and the width thereof can be calculated by appending a space. In this case, the height of the text element can be calculated by appending a character, e.g. the character string “qÄ!”, which produces the greatest possible character height in the font and font size of the text element.

The invention according to claim 16 provides a data conditioning apparatus for the method according to the invention, having a processing unit, a memory and a communication interface,

characterized in that
the processing unit is designed to select at least one content data element for a virtual electronic document;
the processing unit is designed to determine formatting data for the virtual electronic document;
the processing unit is designed to calculate, for the at least one content data element, a page identification value for a page of the virtual electronic document and an element position value on the page identified by the page identification value on the basis of the formatting data;
the processing unit is designed to store an association for the content data element, the page identification value of the content data element and the element position value of the content data element in a database contained in the memory.

This provides an apparatus which produces the data pool required in the method and for the apparatus according to claim 17 in a database, so that the page graphics of the virtual electronic document can be generated in line with the procedure on demand.

The processing unit of this and all other apparatuses and of the arrangement can be realized through the program-based setup of multipurpose hardware, such as multipurpose processors and/or through a combination of programming and application-specific processor components (Application Specific Integrated Circuits, ASICs). In particular, the realization may involve resorting to functions provided by operating systems or middleware and/or to technologies typical of the Internet, such as PHP (PHP Hypertext Preprocessor) and/or JavaScript.

Embodiments of the invention according to claim 16 can be developed in accordance with the subclaims, and also the remaining developments and embodiments of all apparatuses and methods according to the invention. In particular, embodiments of the apparatuses may be realized by virtue of the processing device being designed to implement one or more of the method features.

The invention according to claim 17 provides an apparatus for the provision of at least one page of a virtual electronic document as a computer graphic for retrieval via a network for the method, having a processing unit, a memory and a communication interface which is coupled to the network,

characterized in that
the memory has a database with associations for a content data element, a page identification value of the content data element and an element position value of the content data element, respectively;
the processing unit is designed to evaluate a request for a page of the virtual electronic document to determine a page identification value for the requested page;
the processing unit is designed to access the database to determine at least one content data element and an element position value for the content data element which correspond to the page identification value of the requested page;
the processing unit is designed to calculate a computer graphic on the basis of the formatting data, the content data element determined for the requested page and the associated element position value;
the processing unit is designed to make the computer graphic available as a page of the virtual electronic document for presentation.

Embodiments of the invention according to claim 17 can be developed in accordance with the subclaims, and also the remaining developments and embodiments of all apparatuses and methods according to the invention. In particular, embodiments of the apparatuses may be realized by virtue of the processing device being designed to implement one or more of the method features.

The invention according to claim 18 provides an arrangement for the provision of at least one page of a virtual electronic document as a computer graphic having an apparatus according to claim 16 and an apparatus according to claim 17, for the purpose of performing the method. In this case, the features of the apparatuses may be of integrated design in a common processing unit, a common memory and a common communication interface.

Embodiments of the invention according to claim 18 can be developed in accordance with the subclaims and also the remaining developments and embodiments of all apparatuses and methods according to the invention. In particular, embodiments of the apparatuses may be realized by virtue of the processing device being designed to implement one or more of the method features.

The invention according to claim 19 provides a computer program product, stored on a computer-readable storage medium, which contains computer-readable program means for the execution of the steps of the method according to the invention by a computer. The invention according to claim 20 accordingly provides a computer program product which is embodied in a digital carrier wave. By way of example, the digital carrier wave may be implemented by a wireless or wired electrical or optical signal or by all forms of the embodiment of the information-carrying bits in a medium. Both computer program products are used to perform the method when the program product is executed on a computer.

The computer program product may accordingly be stored on a magnetic or optical data storage medium, such as a CD-ROM, DVD-ROM, floppy disk or hard disk, or in a semiconductor chip, such as a memory chip or a memory portion of a processor.

### BRIEF DESCRIPTION OF THE DRAWINGS

The invention is explained below by way of example with reference to a plurality of figures, in which:

FIG. 1 shows a schematic overview of an exemplary embodiment of the method,

FIG. 2 shows a schematic overview of a first portion of a detail of the exemplary embodiment in FIG. 1,

FIG. 3 shows a schematic overview of a second portion of a detail of the exemplary embodiment in FIG. 1,

FIG. 4 shows a schematic illustration of an exemplary embodiment of the apparatus for provision and/or of the arrangement,

FIG. 5 shows a schematic illustration of an exemplary embodiment of the apparatus for provision and/or of the arrangement with a viewer as a server/client configuration,

FIG. 6 shows an illustration of the row calculation operation according to the method in FIG. 1,

FIG. 7 shows an illustration of the page calculation operation according to the method in FIG. 1, and

FIG. 8 shows a schematic overview of a development of the exemplary embodiment of the method shown in FIG. 1.

### DETAILED DESCRIPTION

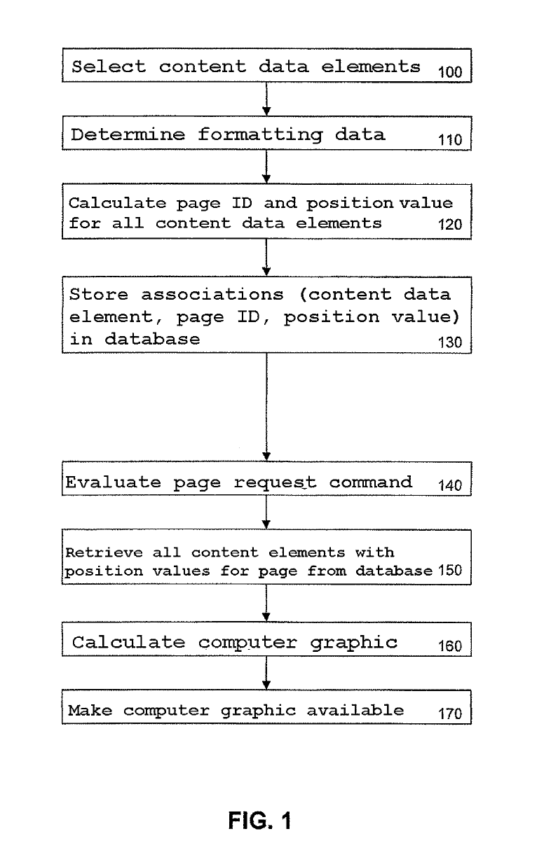

FIG. 1 shows a schematic overview of an exemplary embodiment of the method. In step 100, the processing unit of a computer configured as a server and belonging to a content provider selects a sequentially organized series of content data elements which are intended to form the contents of a virtual electronic document. By way of example, these contents can be input by a user by means of a removable data storage medium or via a network connection. By way of example, content elements can be input on the terminal (client) of a user by means of appropriate dialog elements in a user interface, for example, by means of text input fields, upload dialog elements for incorporating graphic files, and selection elements for specifying configuration options, on the basis of which the client transmits the content data elements to the server via the network.

In this way, it is possible for not only the content data elements, such as formatted or unformatted text, computer graphic files, hyperlinks, background images to be used, invisible elements such as watermarks, multimedia elements such as sound, film and/or animation files, files in proprietary presentation formats (e.g. Adobe Flash) to be transferred to the server, but also data attachments—which are themselves not to be presented—for content elements and control commands.

In this context, the control commands may comprise functions for embedding images (image content data elements), and/or also functions which control the presentation of image content data elements, for example the orientation, size, transparency, etc., thereof. In addition, the control commands may contain functions for determining the configuration of the page background of the document page graphic or graphics to be generated, for inserting a page break, for controlling the presentation of text content data elements (for example according to font, font size, font style, font color), for defining hyperlinks and jump labels to other content data elements, for example on other pages or in other virtual electronic documents, and also functions for calling external commands, e.g. JavaScript programs or the like.

In step 110, the processing device then determines the formatting data which are crucial for the external configuration of the pages (including individual pages) of the virtual document when the position values and page identification values for the content data elements are calculated and when a page computer graphic is produced dynamically on demand. This can be done by evaluating user data and control commands which have been input via a user interface, as described above. In particular, the page height and width and the height and width of the text area (that is to say the useful area of the page, which is obtained from the page size minus the page margins) are determined in this case.

In step 120, calculation pages and calculation rows, which are used as calculation templates, are used to calculate, for each content data element, which page of the virtual electronic document has the content data element associated with it and what position the content data element adopts on its associated page. A page is denoted by determining an appropriate page identification value, and a position on the page is denoted by determining an element position value, which may comprise a coordinate tuple with X and Y coordinates (for example on the basis of an abstract coordinate system for a document page or with reference to the page graphic which is to be provided dynamically at a later time). By way of example, the page identification value may contain the page number, or a combination of the page number and an identification value for the virtual electronic document to which the page belongs.

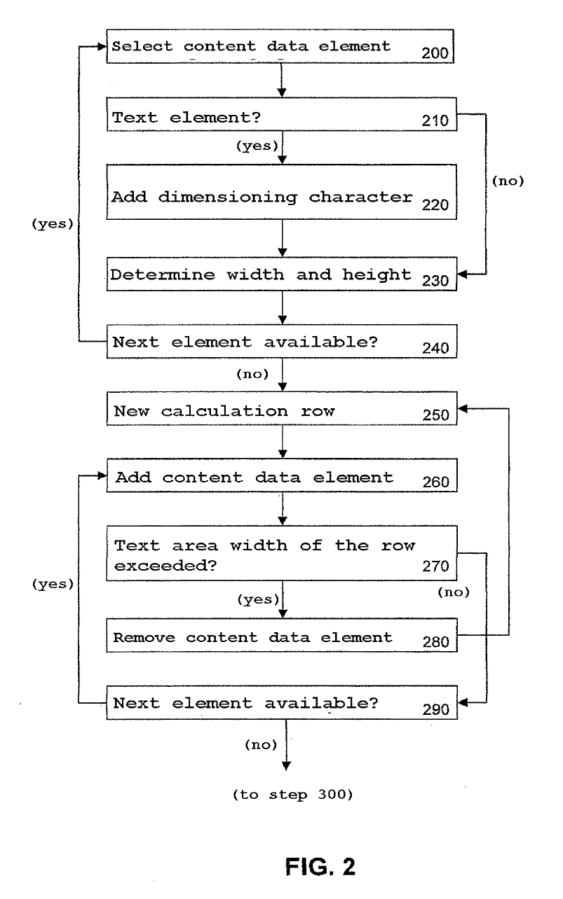

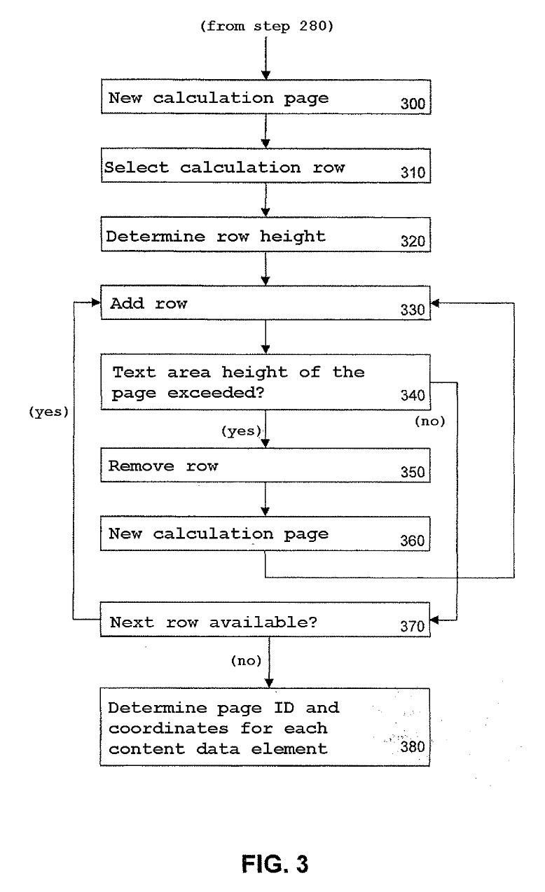

Details of the position calculation are explained more specifically later on with reference to FIGS. 2 and 3.

For each content data element, the processing unit thus forms associations which respectively comprise the content data element (or a reference thereto), the page identification value of the content data element and the element position value of the content data element. In this case, further information may be contained in the respective association.

In step 130, the processing unit uses a DBMS (for example a relational or object-oriented DBMS) to store the associations in a database.

In this case, the database entries for the associations can be combined into one database entry for an entire calculation page, with the association entries of the page entry also being able to be preceded by database entries for the general page formatting. By way of example, these may contain statements relating to the page width, page height, text area width, text area height, page background, mirroring of the page background, whether the current page is a left-hand page of a double page, a page number, color statement for the page number, standard font, standard font size, standard font color, and the content of the page of the book in pure text form (for different search or index functions).

A tabular representation of an extract from a database may have the following structure (in this case the table fields are separated by spaces):

```
  1 450, 550
  2 400, 500
  3 Zeitungspapier.jpg
  4 mirror
  5 6;black
  6 doradani
  7 11
  8 black
  9 SEARCHSTRING:Bilder können an beliebiger Position eingebunden
  werden bild_000801_0087_0044_tsms.jpg oder sogar auf die ganze
  Seite gestreckt werden
10
11 11 25 46 black doradani Bilder
12 11 71 46 black doradani können
13 11 126 46 black doradani an
14 11 152 46 black doradani beliebiger
15 11 226 46 black doradani Position
16 11 285 46 black doradani eingebunden
17 11 376 46 black doradani werden
18 PIC 0 68 X X bild_000801_0087_0044_tsms.jpg
19 11 25 445 black doradani oder
20 11 57 445 black doradani sogar
21 11 96 445 black doradani auf
22 11 117 445 black doradani die
23 11 139 445 black doradani ganze
24 11 179 445 black doradani Seite
25 11 214 445 black doradani gestreckt
26 11 278 445 black doradani werden
27
```

Here, it can be seen that graphic content data elements (bild_{—}000801_{—}0087_{—}0044_tsms.jpg) are incorporated into the database by a reference, in this case by stating the file name, whereas text content data elements (Bilder, können, an, etc.) are stored in the database in a character-encoded form.

In step 140, the processing unit evaluates a page request command which may have been generated by a presentation program on a client connected to the server via the network, for example. This page request command may contain a page identification value, or the processing unit can calculate a page identification value for the page request command, for example when the presentation program produces a command for presenting the next page or the preceding page.

In step 150, the processing unit then retrieves all content data elements from the database which correspond to the page identification value of the retrieved page. If appropriate, this also involves retrieval of the further control commands and/or data attachments associated with the page. As a result, in addition to efficient data management, only a minimum overhead is produced for producing a retrieved page, since all the data required for generating the individual page are retrieved specifically and efficiently.

In step 160, the processing unit then calculates a computer graphic which graphically implements the content elements in line with the formatting and control commands and reproduces them in an individual presentation embodying the requested page of the document.

To this end, the processing unit first of all provides a graphic having the (page) width and height indicated by the formatting data (e.g. PHP: imagecreatetruecolor). If a background graphic is indicated, it is then placed over the entire width and height of the graphic. In this case, if the document is in a double-page presentation, it is possible to establish whether a left-hand or a right-hand page is involved, and the background image can be mirrored around its vertical as appropriate. Subsequently, the processing unit positions the content data elements in the graphic.

This is done for text elements by using an appropriate rendering function to position them in the graphic at the location prescribed by the element position value (e.g. PHP: ImageTTFText).

Graphic elements accordingly can be embedded into the graphic by an appropriate function at the location prescribed by the element position value (e.g. PHP: imagecopyresampled). In this case, the width and height of the image can be adapted on the basis of the width and height of the graphic in accordance with formatting specifications.

The computer graphic calculated in this manner is then made available via the network so as to be transmitted to the client computer and presented thereon.

What this figure does not show in more detail is the sequence for processing a search command. In line with the evaluation of a page request command, the present case may also involve the transmission of a search command for a content data element, such as a character string, from the client to the server, whereupon the processing unit evaluates said search command with the indicated character string and, in a subsequent step, retrieves the associations from the database whose content data element corresponds to the search character string. In this case, the processing unit can then produce a search result, for example, a set of page identification values or page numbers ascertained therefrom, and transmit it to the client for presentation.

In addition, the processing unit can evaluate an access or selection command, wherein the access command has, by way of example, an element position value which stems from a mouse click by the user on the client-end page graphic presentation. In a subsequent step, the processing unit then calls the content data element or the content data elements in the database which correspond to the page identification value of the currently presented page and to the element position value.

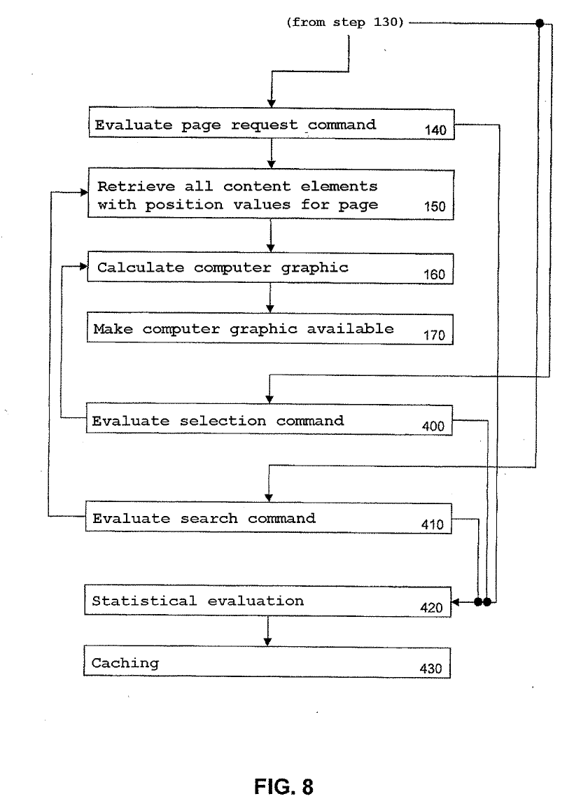

The evaluation of a selection or search command can take place in a manner coordinate to or after the evaluation of a page request command. This is also shown schematically in FIG. 8.

Content data elements which have been selected in this manner or are a search result can have graphic elements added to them as appropriate and be inserted into the page graphic (PHP: imagefilledrectangle).

FIG. 2 shows a schematic overview of a first portion of a detail of the exemplary embodiment in FIG. 1, particularly the calculation of the page identification value and of the element position value for the content data elements.

In step 200, the processing unit first of all selects the next content data element to be processed from the organized set of content data elements and, in step 210, determines whether it is a text element.

If it is a text element, the processing unit temporarily adds characters for the size calculation to the text element in step 220. Thus, only the calculation of the width involves a space being temporarily appended so that the words in the presentation do not touch. Accordingly, only the calculation of the height involves characters being appended which would achieve the greatest possible height and depth in a row of the presentation, such as “gÄ”, or “gÄ!”. In this case, the presentation width and height are calculated in step 230 on the basis of the currently assigned font, font size and font style (e.g. PHP: ImageTTFbbox function).

If it is a graphic element, the processing unit calculates the presentation width and height directly in step 230 (e.g. PHP: getimagesize function).

In step 240, the processing unit checks whether there is also a further content data element available, the width and height of which still need to be determined. If not, the width and height of all content data elements are determined and the processing unit continues with step 250 by first of all providing a calculation row.

This calculation row has content data elements added to it in their order, and at the same time has the widths of the added content data elements added to it, by the processing unit in steps 260, 270 and 290 until the sum of the widths of the content data elements of the calculation row exceeds the text area width of the row. Once the text area width has been exceeded, the processing unit removes the recently added content data element of the calculation row in step 280 and returns it (right at the front) into the set of content data elements which have not yet been associated with a calculation row, whereupon the processing unit in turn provides a new calculation row in step 250 and continues with the associations as described above.

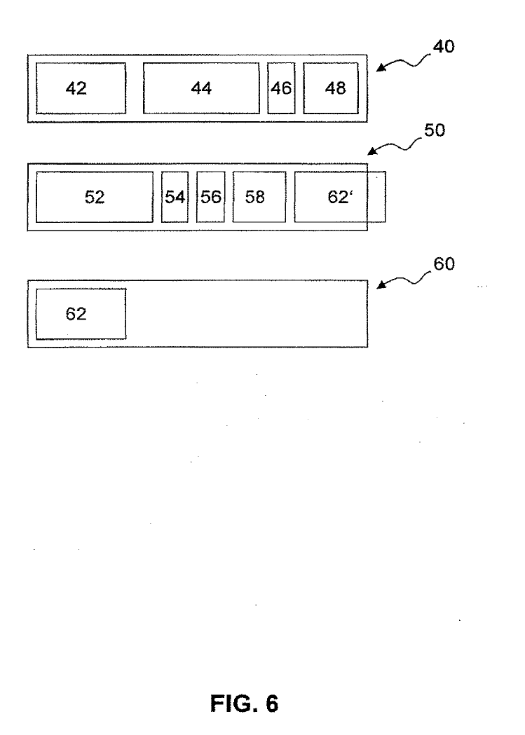

This operation is shown in more detail in FIG. 6. The calculation row 40 has been filled completely with the content data elements 42 to 48. The calculation row 50 would contain an element 62′ which, with the remaining content data elements, would exceed the text area width presented by the calculation row frame on the left and on the right. This element has been removed from the row again as appropriate and has instead been added to a freshly provided calculation row 60 as a content data element 62.

As FIG. 2 also shows, the processing unit continues with step 300 if it establishes in step 290 that there is no further content data element available which has not been associated with a calculation row, that is to say that all content data elements have been associated with a calculation row.

Appropriate control commands allow the association process to be influenced, by way of example, such that individual content data elements, e.g. a graphic, are put into a dedicated row on their own.

FIG. 3 continues the detailed illustration in FIG. 2.

In a basically similar manner to the horizontally running, row-by-row wrapping association between content elements and calculation rows, the calculation rows are now associated with calculation pages in a vertically running and page-by-page wrapping manner.

Accordingly, to this end, the processing unit first of all provides a new calculation page in step 300. In step 310, it then selects the first of the calculation rows not yet associated with a page which are in the order of creation described with reference to FIG. 2, and in step 320 it determines the height of said calculation row. In this case, the height of a calculation row is always determined by the height of that content data element of the calculation row whose height is greatest.

In steps 330, 340 and 370 the processing unit adds calculation rows to the calculation page in their order until the text area height has been exceeded. Once this height has been exceeded, the processing unit removes the calculation row from the calculation page and returns it (right at the front) into the set of calculation rows not yet associated with a calculation page, whereupon the processing unit in turn provides a new calculation page in step 360 and continues with the associations as described above.

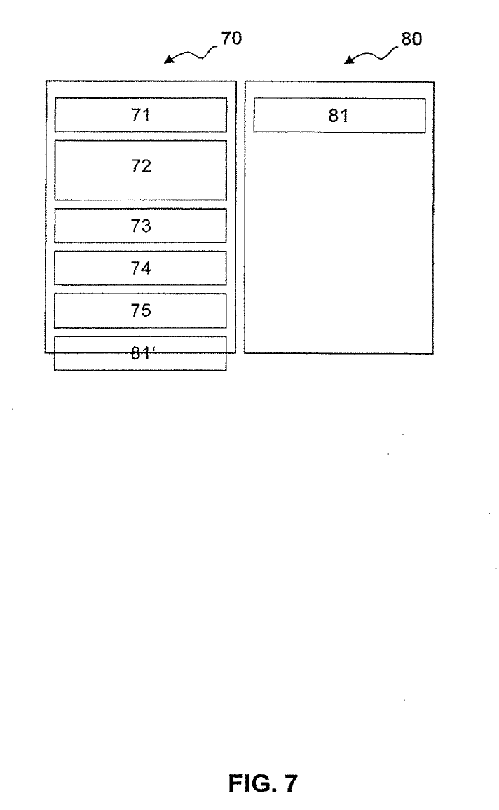

This operation is shown in more detail in FIG. 7. The calculation page 70 with the already associated calculation rows 71 to 75 would contain a row 81′ which, with the other calculation rows, would exceed the text area height shown at the top and bottom by the calculation page frame. This element has accordingly been removed from the page 70 again and instead added to a freshly provided calculation page 80 as calculation row 81.

As FIG. 3 also shows, as soon as the processing unit establishes in step 370 that all calculation rows are assigned to calculation pages and there are no further unassigned calculation pages available, the process is continued with step 380.

In step 380, the processing unit now determines the page identification value and the element position value for each content data element assigned according to row and page. In this case, the page identification value is obtained from the ordinal number of that calculation page to which the content data element is assigned by means of its calculation row, the calculation pages being arranged in the order of the associated content data elements.

If the element position value used is a coordinate tuple, the coordinates are calculated as follows:

The Y coordinate of a content data element is obtained, in principle from the addition of the row heights of all calculation rows on the calculation page of the content data element up to and including the one which has the content data element in question assigned to it.

If content data elements in a row need to be put into a flush-left arrangement, the X coordinate of a content data element is obtained from the sum of the width values of all preceding content data elements in the same calculation row, measured from the left-hand margin of the text area. The following calculation specification is obtained:

X coordinate=Width_of_all_preceding_elements_in_the_row+left-hand_margin_of_the_text_area

If the content data elements in the calculation row need to be positioned flush right, the X coordinate is obtained from subtraction of the sum of the width values of all content data elements in the same calculation row from the text area width plus the sum of the width values of all preceding content data elements in the same calculation row, measured from the left-hand margin of the text area. In this case, the following calculation specification is obtained:

X coordinate=(text_area_width−width_of_all_elements_in_the_row)+width_of_all_preceding_elements_in_the_row+left-hand_margin_of_the_text_area

If the elements in the row need to be positioned centrally, the X coordinate is obtained by dividing by two the subtraction of the sum of the width values of all content data elements in the same calculation row from the text area width plus the sum of the width values of all preceding content data elements in the same calculation row measured from the left-hand margin of the text area. Hence, the following calculation specification is obtained:

X coordinate=(text_area_width−width_of_all_elements_in_the_row)/2+width_of_all_preceding_elements_in_the_row+left-hand_margin_of_the_text_area

If the elements in the row need to be positioned flush left and right, the X coordinate is obtained from the sum of the width values of all preceding content data elements in the same calculation row plus subtraction, divided by the number of intervening spaces, of the sum of the width values of all content data elements in the same calculation row from the text area width measured from the left-hand margin of the text area.

X coordinate=width_of_all_preceding_elements_in_the_row+(text_area_width−width_of_all_elements_in_the_row)/(number_of_elements_in_the_row−1)+left-hand_margin_of_the_text_area

If the content data element is an image which is wider than the text area width but not as wide as the page width, the coordinate X can be shifted to the left by half of this difference in order to improve the visual result. If, correspondingly, the content data element is an image which is higher than the text area height but not as high as the page height, the coordinate Y can be shifted upward by half of this difference.

As already explained with reference to FIG. 1, the data obtained in this manner can now be written to the book page database, with data being written row by row into the following fields for each content data element, (e.g. word): font size, coordinate X, coordinate Y, font color, font, element data. With an image as content data element, the keyword PIC, denoting an image, can be entered into the font size field, and for the font color and font a respective NULL element “X”, “X”, followed by the reference designation (file name) of the image. For images that need to be presented over the entire page, it is accordingly possible for the term FULLPIC to be written instead of the term PIC and the NULL elements “0” instead of the coordinates.

In the present case, the X and Y coordinates relate to the bottom left-hand corner of a text element and to the top left-hand corner of an image element. This allows implementation with the PHP commands “ImageTTFText” and “imagecopyresampled” to be simplified.

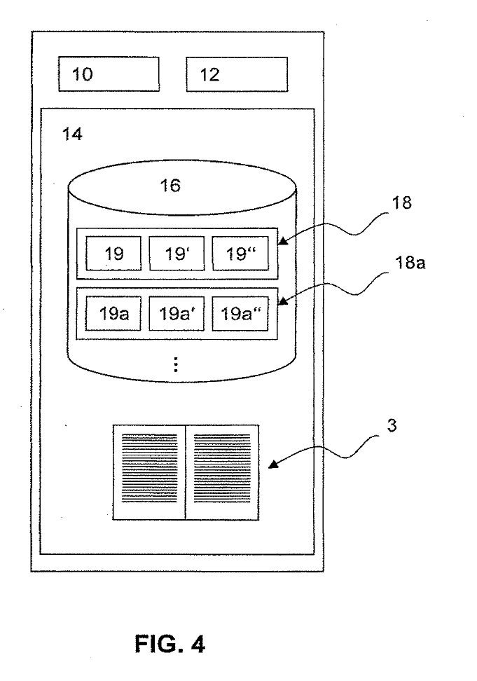

FIG. 4 shows a schematic illustration of an exemplary embodiment of the apparatus for provision and/or of the arrangement.

The apparatus or arrangement shown comprises a processing unit 10, a communication interface 12, which may be realized as a web server and can be connected to a network, and a memory 14 which has a database 16 and a computer graphic 3 generated using the present system.

The processing unit 10, the communication interface 12 and the memory 14 are communicatively connected to one another, for example by means of a computer-internal bus system or by means of a network.

The database 16 has associations 18 and 18a in which a content data element 19 or 19a, a page identification value 19′ or 19a′ and an element position value 19″ or 19a″, respectively are associated.

The communication interface 12 is designed to use the network to receive and send messages and queries and to forward these to the processing unit 10 for further processing. The processing unit is designed to form the functions of the present system which relate to the method and also provides DBMS functions for handling the database 16.

The exemplary embodiment shown in FIG. 4 can be related to the apparatus for providing a page of a virtual electronic document, and also to the data provision apparatus, in which case the presented computer graphic 3 is not contained in the memory, as a person skilled in the art will easily recognize. The exemplary embodiment shown can also be related to the arrangement in which the functions of the presentation apparatus and of the apparatus for provision are in an integrated form.

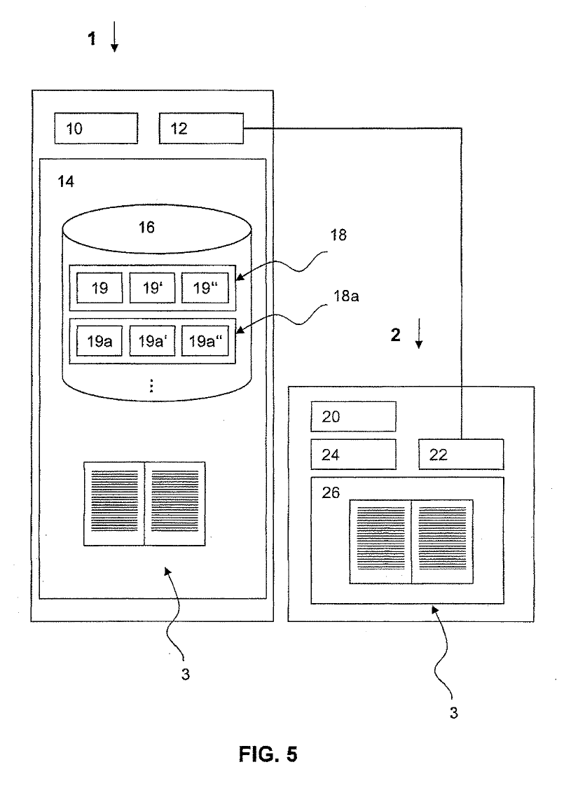

FIG. 5 shows a schematic illustration of an exemplary embodiment of the apparatus for provision and/or of the arrangement, connected to a viewer as a server/client configuration.

The apparatus 1, which has already been described in more detail with reference to FIG. 4, is connected by means of its communication interface 12 in the form of a web server to a network—which in this case is shown as a connecting line—which is in turn connected to the communication interface 22—in the form of a web client—of the viewing device (client computer) 2.

The client computer 2 also comprises a processing unit 20, a memory 24 and a user interface 26.

The processing unit 20 is designed to execute a program—stored locally or transmitted by the server 1 via the network beforehand—which firstly provides display functions for a computer graphic 3 via a user interface 26 and retrieval functions for individual pages and secondly, in a similar manner, also transmits input options for information such as content data elements or formatting commands for the creation of virtual electronic documents on the server. When a user on the client 2 uses a retrieval function, an appropriate retrieval command is transmitted to the server, which in response transmits the relevant page of the virtual electronic document, said page then being presented by the client. Accordingly, the client end can produce selection or search commands to the server, and all data and instructions which are required for creating a virtual electronic document can be input via the user interface 26 of the client 2 and transmitted to the server 1.

FIG. 8 shows a schematic overview of a development of the embodiment of the method, as has been described with reference to FIG. 1. Steps 130 to 170 correspond to those indicated with reference to FIG. 1.

The apparatuses which have been described above with reference to FIGS. 4 and 5 are set up to implement the development by virtue of their respective processing unit 10 being designed to perform a selection or all of the method steps.

As described with reference to FIG. 1, a page request command, search command and/or selection command coming from the user computer (client) 2 is processed by the apparatus (server) 1. This processing takes place in step 140 for a page request command, step 400 for a selection command and step 410 for a search command. For details of these evaluation steps reference is made to the description relating to FIG. 1. The evaluations can take place concurrently, that is to say in parallel, which is indicated by the plurality of flow arrows coming from step 130.

Each of the evaluations from steps 140, 400 and 410 then leads to the normal operation of the further processing (steps 140 and 410 lead to step 150, step 400 leads to 160) and additionally, for example also in parallel, to step 420.

In step 420, the respective request, selection or search command is statistically evaluated. Thus, this step can be used to determine, for each content element, the frequency with which it becomes the subject of one of these commands, and/or time windows in which particular content elements become the subject of these commands particularly frequently can be determined.

In the present case, these results are used for appropriate caching in step 430. This involves the content elements which become the subjects of these commands particularly frequently being stored in the memory 14 in access-optimized fashion, so that access can take place particularly efficiently. If the memory comprises portions with fast memory access and portions with slower memory access, the content elements which become the subject of these commands particularly frequently can be stored in the memory portions with fast memory access.

Similarly, the content elements which become the subject of these commands particularly frequently within that time window into which the current time falls can be stored in the memory 14 in access-optimized fashion, so that access can take place particularly efficiently.

The statistical evaluations can also be used to analyze the user behavior and to provide the user with such contents, e.g. by means of banner advertising, which correspond to the content elements which are affected particularly frequently.

In this way, the retrieval of the content elements in step 150 is speeded up by virtue of the retrieval taking place from the access-optimized memory or by involving access-optimized memory portions. The present system therefore provides the opportunity to provide pages of an electronic document for retrieval via a network. This allows pleasing presentation of the provided contents on small display units too, and simultaneously complicates undesirable electronic further processing of the contents and affords a high level of storage and data transmission efficiency.

As a person skilled in the art can readily glean from the preceding illustrations and explanations, some embodiments have the method steps described implemented in software, the program instructions of which prompt the execution of the method steps on a processor, such as the processing unit. This software is contained in the memory 14 of the apparatus 1 (see FIG. 4 and FIG. 5).

This applies to the arrangement 1 for the provision of at least one page of a virtual electronic document as a computer graphic, in which the functions or embodiments of the processing unit which implement the method are present in integrated form in a system, wherein the system can be implemented in all embodiments equivalently as a server or web server, in the same way as in cases in which the arrangement 1 is implemented such that it contains a data conditioning apparatus (designed to perform method steps 100-130) and an apparatus for providing at least one page of a virtual electronic document as a computer graphic (designed to perform method steps 140-170). In this case, the apparatus may likewise be in a form equivalently as a server or web server in all embodiments. In addition, the data conditioning apparatus may be realized by a data conditioning software module which realizes steps 100-130, and the apparatus for provision may be realized by a provision software module which realizes steps 140-170, on a single computer and arranged in the memory thereof. In this case, as a person skilled in the art will readily recognize, the terminal of the user, that is to say the viewing device (viewer) which in all embodiments can be implemented equivalently as a client or web client or comprises the latter, begins to interact with the arrangement or apparatus for provision which is in the form of a server or web server.

### LIST OF REFERENCE SYMBOLS

1 Apparatus or arrangement for the provision of a page of a virtual electronic document
2 User computer (client)
3 Computer graphic
10 Processing unit
12 Communication interface
14 Memory
16 Database of associations
18, 18a First and second associations
19, 19a First and second content data elements
19′, 19a′ Page identification value of the first and second content data elements
19″, 19a″ Element position value of the first and second content data elements
20 Processing unit
22 Communication interface
24 Memory
26 User interface
40 Calculation row element
42-48 Positioned content data elements
50 Calculation row element
52-58 Positioned content data elements
60 Calculation row element
62 Repositioned content data element
62′ Content data element to be repositioned
70 Calculation page element
71-75 Positioned row elements
80 Calculation page element
81 Repositioned calculation page element
81′ Calculation page element to be repositioned
100 Select content data element
110 Determine the formatting data
120 Calculate the page identification value and the element position value for each content data element
130 Store associations in database
140 Evaluate a page request command
150 Retrieve all content elements of the requested page
160 Calculate a computer graphic with the content elements of the page
170 Make the computer graphic available
200 Select a content data element
210 Check whether text element
220 Add dimensioning characters which are not to be presented
230 Determine the width and height of the content data element
240 Check whether a subsequent content data element is available
250 Open a new calculation row
260 Add the content data element
270 Check whether text area width of the row has been exceeded
280 Remove the content data element from the row
290 Check whether a subsequent content data element is available
300 Open a new calculation page
310 Select a calculation row
320 Determine the row height
330 Add the row to the calculation page
340 Check whether text area height of the page has been exceeded
350 Remove the row from the calculation page
360 Open a new calculation page
370 Check whether a subsequent row is available
380 Determine the page identification value and the coordinates for each content data element
400 Evaluate a selection command
410 Evaluate a search command
420 Statistical evaluation
430 Caching

1. A method for the provision of at least one page of a virtual electronic document as a computer graphic (3) for retrieval via a network, having the following steps:
at least one content data element (19, 19a) is selected (100) for a virtual electronic document;
the formatting data are determined (110) for the virtual electronic document;
a page identification value (19′, 19a′) for a page of the virtual electronic document and an element position value (19″, 19a″) on the page identified by the page identification value are calculated (120) for the at least one selected content data element on the basis of the formatting data;
an association (18, 18a) for the selected content data element, the page identification value of the selected content data element and the element position value of the selected content data element is stored (130) in a database (16);
a request for a page of the virtual electronic document is evaluated (140) to determine a page identification value for the requested page;
the database is accessed to determine (150) at least one content data element and an element position value for the determined content data element which correspond to the page identification value of the requested page;
a computer graphic is calculated (160) on the basis of the formatting data, the content data element determined for the requested page and the associated element position value;
the computer graphic is made available (170) as a page of the virtual electronic document for presentation.

2. The method as claimed in claim 1, characterized in that the request for a page of the virtual electronic document is evaluated when the request is received by a web server (12).

3. The method as claimed in one of claims 1 and 2, characterized in that the computer graphic is made available through the transmission of a graphic file by a web server (12).

4. The method as claimed in one of claims 1 to 3, characterized in that an access command for a content data element of the made-available page of the virtual electronic document is evaluated on the basis of the element position value thereof.

5. The method as claimed in claim 4, characterized in that the content data element associated with the page identification value of the made-available page and with the element position value is ascertained by accessing the database.

6. The method as claimed in one of claims 1 to 5, characterized in that a search command associated with the search term is evaluated and content data elements of the virtual electronic document are ascertained which correspond to the search term.

7. The method as claimed in one of claims 1 to 6, characterized in that the formatting data comprise a page width value and/or a page height value and/or a text area width value and/or a text area height value.

8. The method as claimed in one of claims 1 to 7, characterized in that the element position value is calculated by calculating the dimensions of the selected content data element.

9. The method as claimed in one of claims 1 to 8, characterized in that a sequence of content data elements is selected.

10. The method as claimed in claim 9, characterized in that a row is calculated (200-290) to horizontally join together (260) the successive selected content data elements on the basis of the addition of the width of the respective content data element until the text area width value has been reached (270).

11. The method as claimed in claim 10, characterized in that a page is calculated (300-380) to vertically join together (330) the successive rows on the basis of the addition of the height of the rows until the text area height value has been reached (340), the height of a row being determined by the highest content data element in the row.

12. The method as claimed in claim 11, characterized in that the selected content data element is allocated (380) that page identification value which corresponds to the calculated page to which the selected content data element has been appended.

13. The method as claimed in claim 12, characterized in that the selected content data element is allocated (380) that element position value which corresponds to the position of the selected content data element on the calculated page to which the selected content data element has been appended.

14. The method as claimed in one of claims 1 to 11, characterized in that the selected content data element has a text element and the width thereof is calculated by appending (220) a space.

15. The method as claimed in claim 12, characterized in that the height of the text element is calculated by appending (220) a character which produces the greatest possible character height in the font and font size of the text element.

16. A data conditioning apparatus (1) for a method as claimed in one of claims 1 to 15, having a processing unit (10), a memory (14) and a communication interface (12),
characterized in that
the processing unit is designed to select at least one content data element (19, 19a) for a virtual electronic document;
the processing unit is designed to determine formatting data for the virtual electronic document;
the processing unit is designed to calculate, for the at least one selected content data element, a page identification value (19′, 19a′) for a page of the virtual electronic document and an element position value (19″, 19a″) on the page identified by the page identification value on the basis of the formatting data;
the processing unit is designed to store an association (18, 18a) for the selected content data element, the page identification value of the selected content data element and the element position value of the selected content data element in a database contained in the memory.

17. An apparatus (1) for the provision of at least one page of a virtual electronic document as a computer graphic (3) for retrieval via a network for a method as claimed in one of claims 1 to 15 having a processing unit (10), a memory (14) and a communication interface (12) which is coupled to the network
characterized in that
the memory has a database (16) with associations (18, 18a) for a content data element (19, 19a), a page identification value (19′, 19a′) of the content data element and an element position value (19″, 19a″) of the content data element, respectively;
the processing unit is designed to evaluate a request for a page of the virtual electronic document to determine a page identification value for the requested page;
the processing unit is designed to access the database to determine at least one content data element and an element position value for the determined content data element which correspond to the page identification value of the requested page;
the processing unit is designed to calculate a computer graphic on the basis of the formatting data, the content data element determined for the requested page and the associated element position value;
the processing unit is designed to make the computer graphic available as a page of the virtual electronic document for presentation.

18. An arrangement (1) for the provision of at least one page of a virtual electronic document as a computer graphic (3) having an apparatus as claimed in claim 16 and an apparatus as claimed in claim 17, for a method as claimed in one of claims 1 to 15.

19. A computer program product, stored on a computer-readable storage medium, having computer-readable program means for the performance of the method as claimed in one of claims 1 to 15 by a computer.

20. A computer program product, embodied in a digital carrier wave, having computer-readable program means for the performance of the method as claimed in one of claims 1 to 15 by a computer.
